(19) United States
(12) Patent Application Publication
(10) Pub. No.: US 2023/0354267 A1
(43) Pub. Date: Nov. 2, 2023

(54) SOUNDING REFERENCE SIGNAL RESOURCE CONFIGURATION

(71) Applicant: QUALCOMM Incorporated, San Diego, CA (US)

(72) Inventors: Yi HUANG, San Diego, CA (US); Yu ZHANG, San Diego, CA (US); Peter GAAL, San Diego, CA (US)

(21) Appl. No.: 17/661,519

(22) Filed: Apr. 29, 2022

(51) Int. Cl. H04W 72/02; H04W 72/04; H04L 5/00

(52) U.S. Cl. CPC H04W 72/02; H04W 72/042; H04L 5/0051

(57) ABSTRACT

Various aspects of the present disclosure generally relate to wireless communication. In some aspects, a user equipment (UE) may receive a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports. The UE may receive information indicating a set of selected SRS resources, including the at least five SRS resources, for an uplink transmission. The UE may transmit the uplink transmission based at least in part on the set of selected SRS resources. Numerous other aspects are described.

### FIELD OF THE DISCLOSURE

Aspects of the present disclosure generally relate to wireless communication and to techniques and apparatuses for sounding reference signal (SRS) resource configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a WiFi link, or a Bluetooth link).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports. The method may include receiving information indicating a set of selected SRS resources, including the at least five SRS resources, for an uplink transmission. The method may include transmitting the uplink transmission based at least in part on the set of selected SRS resources.

Some aspects described herein relate to a method of wireless communication performed by a network node. The method may include receiving or transmitting a configuration of at least one SRS resource set including at least five SRS resources or at least two SRS resource sets collectively including the at least five SRS resources, each SRS resource, of the at least five SRS resources, corresponding to an SRS port of at least five SRS ports. The method may include transmitting information indicating a set of selected SRS resources, including the at least five SRS resources, for an uplink transmission.

Some aspects described herein relate to a UE for wireless communication. The user equipment may include a memory and one or more processors coupled to the memory. The one or more processors may be configured to receive a configuration of at least one SRS resource set including at least five SRS resources or at least two SRS resource sets collectively including the at least five SRS resources, each SRS resource, of the at least five SRS resources, corresponding to an SRS port of at least five SRS ports. The one or more processors may be configured to receive information indicating a set of selected SRS resources, including the at least five SRS resources, for an uplink transmission. The one or more processors may be configured to transmit the uplink transmission based at least in part on the set of selected SRS resources.

Some aspects described herein relate to a network node for wireless communication. The network node may include a memory and one or more processors coupled to the memory. The one or more processors may be configured to receive or transmit a configuration of at least one SRS resource set including at least five SRS resources or at least two SRS resource sets collectively including the at least five SRS resources, each SRS resource, of the at least five SRS resources, corresponding to an SRS port of at least five SRS ports. The one or more processors may be configured to transmit information indicating a set of selected SRS resources, including the at least five SRS resources, for an uplink transmission.

Some aspects described herein relate to a non-transitory computer-readable medium that stores a set of instructions for wireless communication by a UE. The set of instructions, when executed by one or more processors of the UE, may cause the UE to receive a configuration of at least one SRS resource set including at least five SRS resources or at least two SRS resource sets collectively including the at least five SRS resources, each SRS resource, of the at least five SRS resources, corresponding to an SRS port of at least five SRS ports. The set of instructions, when executed by one or more processors of the UE, may cause the UE to receive information indicating a set of selected SRS resources, including the at least five SRS resources, for an uplink transmission. The set of instructions, when executed by one or more processors of the UE, may cause the UE to transmit the uplink transmission based at least in part on the set of selected SRS resources.

Some aspects described herein relate to a non-transitory computer-readable medium that stores a set of instructions for wireless communication by a network node. The set of instructions, when executed by one or more processors of the network node, may cause the network node to receive or transmit a configuration of at least one SRS resource set including at least five SRS resources or at least two SRS resource sets collectively including the at least five SRS resources, each SRS resource, of the at least five SRS resources, corresponding to an SRS port of at least five SRS ports. The set of instructions, when executed by one or more processors of the network node, may cause the network node to transmit information indicating a set of selected SRS resources, including the at least five SRS resources, for an uplink transmission.

Some aspects described herein relate to an apparatus for wireless communication. The apparatus may include means for receiving a configuration of at least one SRS resource set including at least five SRS resources or at least two SRS resource sets collectively including the at least five SRS resources, each SRS resource, of the at least five SRS resources, corresponding to an SRS port of at least five SRS ports. The apparatus may include means for receiving information indicating a set of selected SRS resources, including the at least five SRS resources, for an uplink transmission. The apparatus may include means for transmitting the uplink transmission based at least in part on the set of selected SRS resources.

Some aspects described herein relate to an apparatus for wireless communication. The apparatus may include means for receiving or transmitting a configuration of at least one SRS resource set including at least five SRS resources or at least two SRS resource sets collectively including the at least five SRS resources, each SRS resource, of the at least five SRS resources, corresponding to an SRS port of at least five SRS ports. The apparatus may include means for transmitting information indicating a set of selected SRS resources, including the at least five SRS resources, for an uplink transmission.

Aspects generally include a method, apparatus, system, computer program product, non-transitory computer-readable medium, user equipment, base station, wireless communication device, network node, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sounding reference signal (SRS) resource sets, in accordance with the present disclosure.

FIG. 4 is a diagram illustrating an example of signaling associated with SRS resource configuration to support non-codebook uplink transmission, in accordance with the present disclosure.

FIGS. 5 and 6 are diagrams illustrating examples of at least one SRS resource set, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

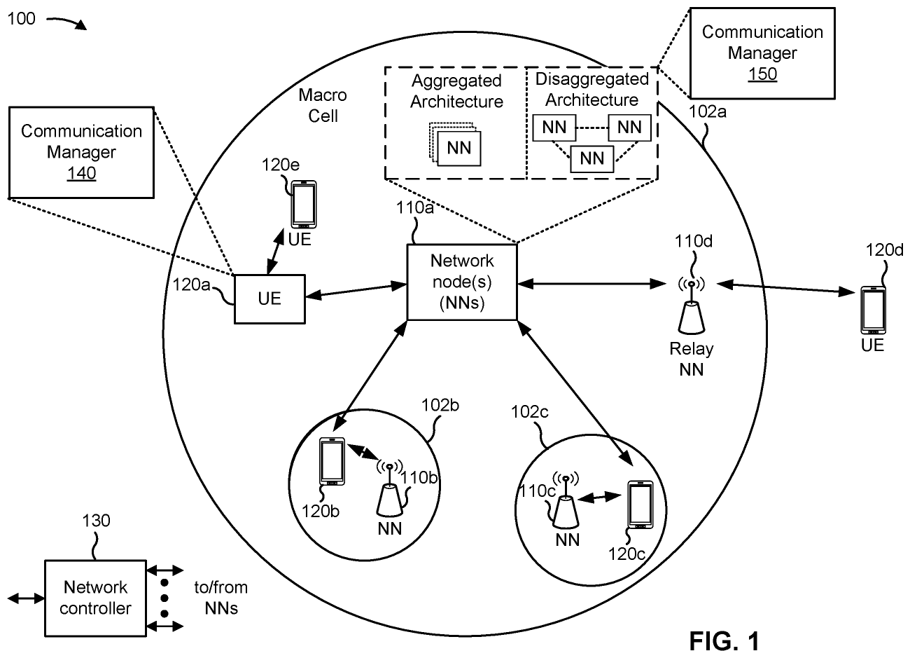

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 includes two or more non-co-located network nodes. A disaggregated network node may be configured to utilize a protocol stack that is physically or logically distributed among two or more nodes (such as one or more central units (CUs), one or more distributed units (DUs), or one or more radio units (RUs)).

In some examples, a network node 110 includes an entity that communicates with UEs 120 via a radio access link, such as an RU. In some examples, a network node 110 includes an entity that communicates with other network nodes 110 via a fronthaul link or a midhaul link, such as a DU. In some examples, a network node 110 includes an entity that communicates with other network nodes 110 via a midhaul link or a core network via a backhaul link, such as a CU. In some aspects, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another and/or to one or more other network nodes 110 in the wireless network 100 through various types of fronthaul, midhaul, or backhaul interfaces, such as a direct physical connection, an air interface, or a virtual network, using any suitable transport network.

In some aspects, a network node 110 may provide communication coverage for a particular geographic area. In the Third Generation Partnership Project (3GPP), the term “cell” can refer to a coverage area of a base station and/or a base station subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station for a macro cell may be referred to as a macro base station. A base station for a pico cell may be referred to as a pico base station. A base station for a femto cell may be referred to as a femto base station or an in-home base station. In the example shown in FIG. 1, the network node 110a may be a macro base station for a macro cell 102a, the network node 110b may be a pico base station for a pico cell 102b, and the network node 110c may be a femto base station for a femto cell 102c. A base station may support one or multiple (e.g., three) cells.

In some examples, a cell may not necessarily be stationary, and the geographic area of the cell may move according to the location of a network node 110 that is mobile (e.g., a mobile base station).

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120 or network nodes 110. In the example shown in FIG. 1, the network node 110d (e.g., a relay base station) may communicate with the network node 110a (e.g., a macro base station) and the UE 120d in order to facilitate communication between the network node 110a and the UE 120d. A network node 110 that relays communications may be referred to as a relay station, a relay base station, a relay node, a relay, or the like.

The wireless network 100 may be a heterogeneous network that includes network nodes 110 of different types, such as macro base stations, pico base stations, femto base stations, relay base stations, TRPs, RUs, or the like. These different types of network nodes 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul or midhaul communication link. The network nodes 110 may communicate with one another directly or indirectly via a wireless or wireline backhaul communication link. In some aspects, the network controller 130 may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

Deployment of communication systems, such as 5G NR systems, may be arranged in multiple manners with various components or constituent parts. In a 5G NR system, or network, a network node may be implemented in an aggregated or disaggregated architecture. For example, a network node, or one or more units (or one or more components) performing network node functionality, may be implemented as an aggregated network node (sometimes referred to as a standalone base station or a monolithic base station) or a disaggregated network node. “Network entity” or “network node” may refer to a disaggregated network node, an aggregated network node, or one or more entities of a disaggregated network node (such as one or more CUs, one or more DUs, one or more RUs, or a combination thereof).

In some aspects, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of network node functionality. For example, disaggregated network nodes may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated network node may include functionality implemented across two or more units at various physical locations, as well as functionality implemented for at least one unit virtually, which may enable flexibility in network design.

In some aspects, the UE 120 may include a communication manager 140. As described in more detail elsewhere herein, the communication manager 140 may receive a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports; receive information indicating a set of selected SRS resources, including the at least five SRS resources, for an uplink transmission; and transmit the uplink transmission based at least in part on the set of selected SRS resources. Additionally, or alternatively, the communication manager 140 may perform one or more other operations described herein.

In some aspects, the network node 110 may include a communication manager 150. As described in more detail elsewhere herein, the communication manager 150 may receive or transmit a configuration of at least one SRS resource set including at least five SRS resources or at least two SRS resource sets collectively including the at least five SRS resources, each SRS resource, of the at least five SRS resources, corresponding to an SRS port of at least five SRS ports; and transmit information indicating a set of selected SRS resources, including the at least five SRS resources, for an uplink transmission. Additionally, or alternatively, the communication manager 150 may perform one or more other operations described herein.

As indicated above, FIG. 1 is provided as an example. Other examples may differ from what is described with regard to FIG. 1.

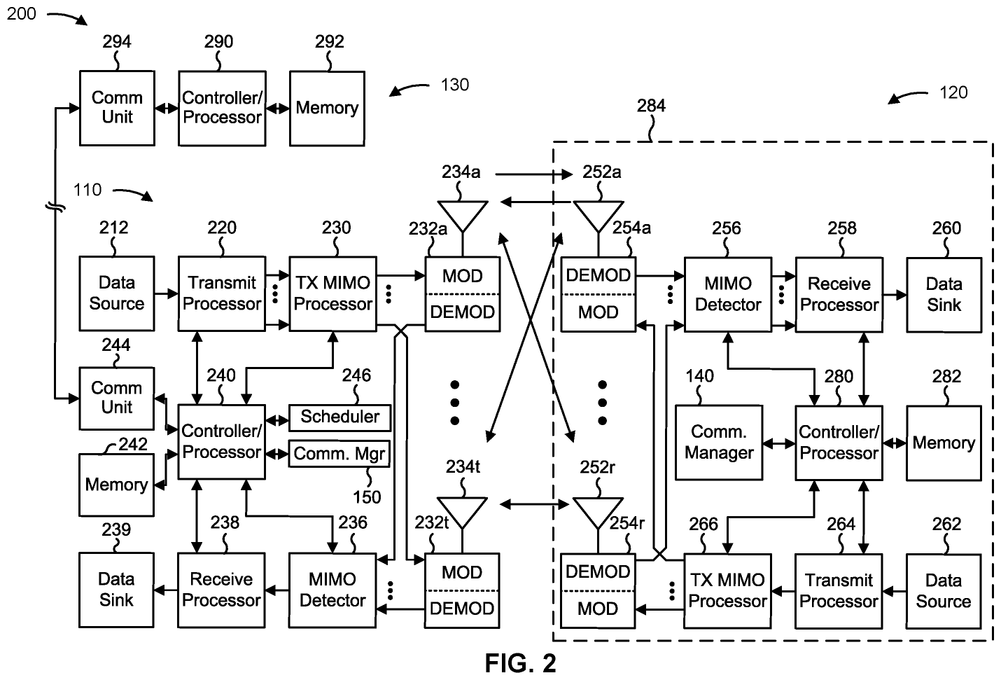

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. For example, some network nodes 110 may not include radio frequency components. In some examples, one or more components illustrated as included in the network node 110 of example 200 may be implemented separately from the network node of example 200. For example, one or more radio frequency components (e.g., antenna 234, modem 232, TX MIMO processor 230, transmit processor 220, receive processor 238, or MIMO detector 236) may be implemented at an RU, and the network node 110 may be a DU associated with the RU.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

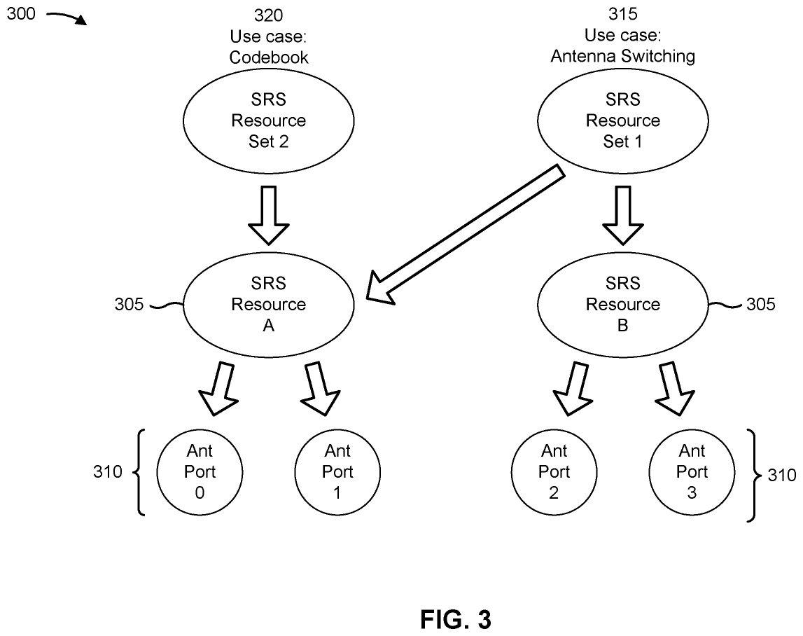

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-10).

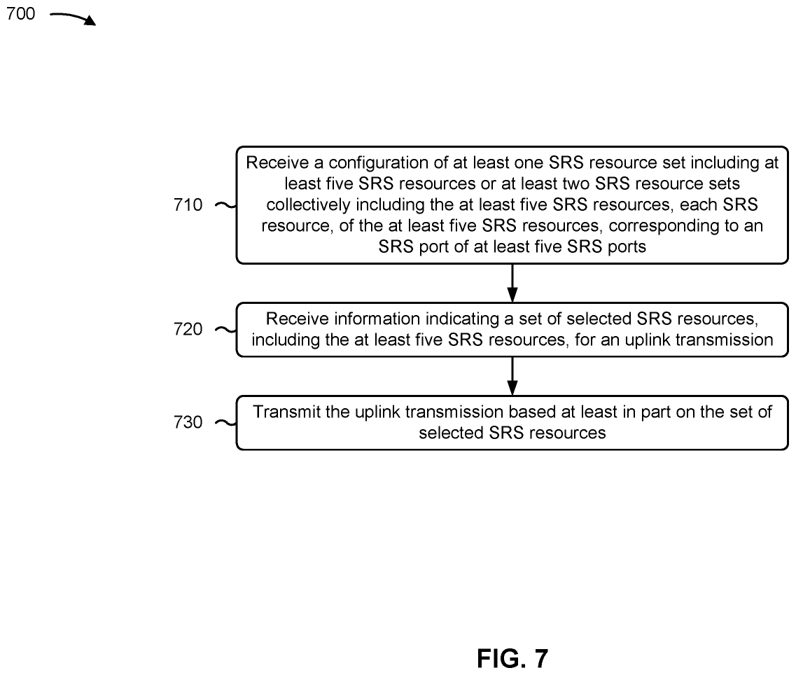

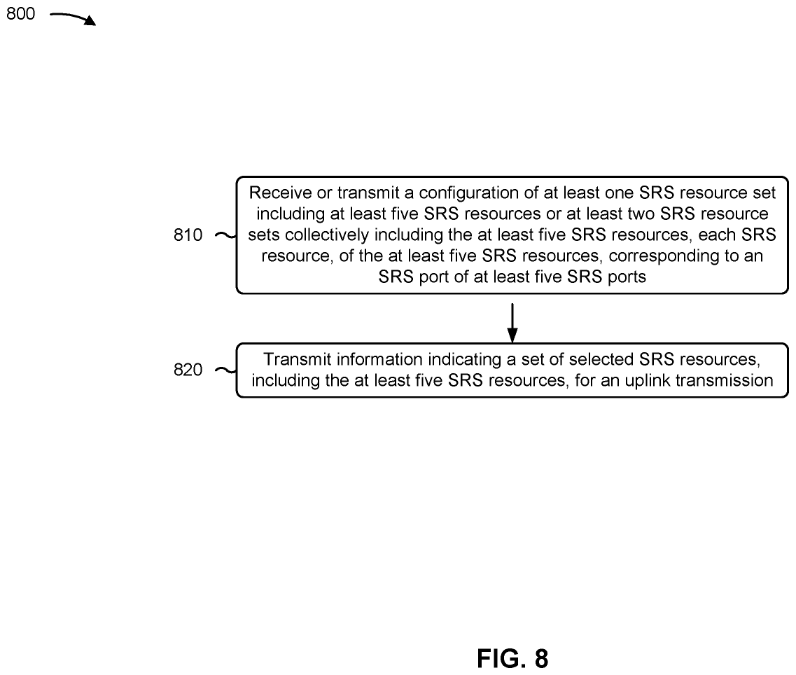

The controller/processor 240 of the network node 110, the controller/processor 280 of the UE 120, and/or any other component(s) of FIG. 2 may perform one or more techniques associated with SRS transmission, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving a configuration of at least one SRS resource set including at least five SRS resources or at least two SRS resource sets collectively including the at least five SRS resources, each SRS resource, of the at least five SRS resources, corresponding to an SRS port of at least five SRS ports; means for receiving information indicating a set of selected SRS resources, including the at least five SRS resources, for an uplink transmission; and/or means for transmitting the uplink transmission based at least in part on the set of selected SRS resources. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving or transmitting a configuration of at least one SRS resource set including at least five SRS resources or at least two SRS resource sets collectively including the at least five SRS resources, each SRS resource, of the at least five SRS resources, corresponding to an SRS port of at least five SRS ports; and/or means for transmitting information indicating a set of selected SRS resources, including the at least five SRS resources, for an uplink transmission. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of SRS resource sets, in accordance with the present disclosure.

A network node may configure a UE with one or more SRS resource sets to allocate resources for SRS transmissions by the UE. For example, a configuration for SRS resource sets may be indicated in a radio resource control (RRC) message (e.g., an RRC configuration message or an RRC reconfiguration message). As shown by reference number 305, an SRS resource set may include one or more SRS resources, which may include time resources and/or frequency resources (e.g., a slot, a symbol, a resource block, and/or a periodicity for the time resources).

As shown by reference number 310, an SRS resource may indicate one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. Transmitting an SRS in accordance with an SRS resource is referred to as sounding the SRS resource. In some examples, when an SRS resource is associated with an SRS port, transmitting an SRS in accordance with the SRS resource is referred to as sounding the SRS port. In some examples, the configuration for an SRS resource set may indicate a use case (e.g., in an SRS-SetUse information element) for the SRS resource set. In some examples, a use case is referred to as a usage. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a network node may use an antenna switching SRS (e.g., an SRS transmitted using a resource of an antenna switching SRS resource set) to acquire downlink CSI (e.g., to determine a downlink precoder to be used to communicate with the UE).

A codebook SRS resource set may be used to indicate uplink CSI when a network node indicates an uplink precoder to the UE. For example, when the network node is configured to indicate an uplink precoder to the UE (e.g., using a precoder codebook), the network node may use a codebook SRS (e.g., an SRS transmitted using a resource of a codebook SRS resource set) to acquire uplink CSI (e.g., to determine an uplink precoder to be indicated to the UE and used by the UE to communicate with the network node). In some aspects, virtual ports (e.g., a combination of two or more antenna ports) with a maximum transmit power may be supported at least for a codebook SRS.

A non-codebook SRS resource set may be used to determine uplink CSI when the UE selects an uplink precoder (e.g., instead of the network node indicated an uplink precoder to be used by the UE). For example, when the UE is configured to select an uplink precoder, the network node may use a non-codebook SRS (e.g., an SRS transmitted using a resource of a non-codebook SRS resource set) to acquire uplink CSI. In this case, the non-codebook SRS may be precoded using a precoder selected by the UE (e.g., which may be indicated to the network node). An SRS resource of a non-codebook SRS resource set may be associated with an SRS port (e.g., one SRS port per SRS resource). The UE may use a different precoder for each SRS port (and thus each SRS resource). The UE may sound a precoded SRS port, meaning that the UE may transmit an SRS on an SRS resource configured with the SRS port using a precoder associated with the SRS port. The network node may configure a number of SRS resources, each with one SRS port (e.g., a different SRS port for each SRS resource). The network node may trigger transmission using one or more SRS ports and may perform estimation associated with these SRS ports sequentially in the time domain on time/frequency resources associated with the corresponding SRS resources. The network node may select, out of the sounded SRS port(s), how many and which SRS ports should be used to transmit a non-codebook transmission such as a physical uplink shared channel (PUSCH). For example, the network node may select X SRS ports, where X is a rank of the non-codebook transmission. Thus, the network node may select one or more precoders for a non-codebook PUSCH transmission based at least in part on a non-codebook SRS resource set.

An SRS port (or corresponding SRS resource) may be mapped to one or more antenna ports (each antenna port corresponding to a physical antenna of the UE). Each antenna port (e.g., antenna) may have a row of a one-column precoder vector. A signal for sounding of an SRS resource configured with the SRS port may originate in the baseband, be processed according to the precoder vector, and transmitted on the corresponding antenna port(s). Additional description of SRS transmission for non-codebook transmission is provided below.

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated (e.g., may be activated for SRS transmission until the periodic SRS resource is deconfigured). A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

In some aspects, the UE may be configured with a mapping between SRS ports (e.g., antenna ports) and corresponding SRS resources. The UE may transmit an SRS on a particular SRS resource using an SRS port indicated in the configuration. In some aspects, an SRS resource may span N adjacent symbols within a slot (e.g., where N equals 1, 2, or 4). The UE may be configured with X SRS ports (e.g., where X≤4). In some aspects, each of the X SRS ports may mapped to a corresponding symbol of the SRS resource and used for transmission of an SRS in that symbol.

As shown in FIG. 3, in some aspects, different SRS resource sets indicated to the UE (e.g., having different use cases) may overlap (e.g., in time and/or in frequency, such as in the same slot). For example, as shown by reference number 315, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 320, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE may not transmit codebook SRSs in SRS Resource B (e.g., the second time-frequency resource) using antenna port 2 and antenna port 3.

A UE may perform non-codebook uplink transmission (such as non-codebook PUSCH transmission) using a number of transmit antennas (equivalently, a number of antenna ports). For example, a UE may use 4 transmit antennas for 4 Tx non-codebook PUSCH transmission. There are some situations (such as a UE communicating with a or including a customer premises equipment (CPE), a fixed wireless access (FWA) node, a vehicle node, or an industrial device) where it may be beneficial to perform non-codebook transmission using more than 4 transmit antennas, such as to enable the transmission of uplink communications by a UE using more than 4 layers. However, in some deployments, an SRS resource set for non-codebook transmission (such as an SRS resource set configured with a nonCodebook usage) may be constrained to include at most 4 SRS resources (corresponding to 4 SRS ports and thus 4 precoders). Furthermore, in some deployments, a UE can only be configured with a single SRS resource set for non-codebook transmission. If at most 4 SRS resources can be configured in a non-codebook transmission SRS resource set, then sounding of the non-codebook transmission SRS resource set may not provide adequate information to support non-codebook transmission using more than 4 layers. Thus, performance of non-codebook transmission using more than 4 layers is degraded and throughput is reduced.

Techniques described herein provide configuration of at least one SRS resource set (e.g., a single SRS resource set or multiple SRS resource sets) that collectively includes at least five SRS resources. For example, the at least one SRS resource set may be configured for non-codebook usage. In some examples, the single SRS resource set includes at least five SRS resources. In some other examples, multiple SRS resource sets collectively include at least five SRS resources (e.g., four SRS resources per SRS resource set, or a different number of SRS resources per SRS resource set). Some techniques described herein provide signaling associated with SRS resource indication for a non-codebook transmission, such as signaling to indicate a set of selected SRS resources of a single SRS resource set, or signaling to indicate respective sets of selected SRS resources of multiple SRS resource sets. For example, some techniques described herein provide overhead reduction (e.g., reduction of a number of bits) for SRS resource indication associated with non-codebook transmission using more than 4 layers. In this way, channel sounding for non-codebook transmission using more than 4 layers is supported, which improves performance and increases throughput.

As indicated above, FIG. 3 is provided as an example. Other examples may differ from what is described with regard to FIG. 3.

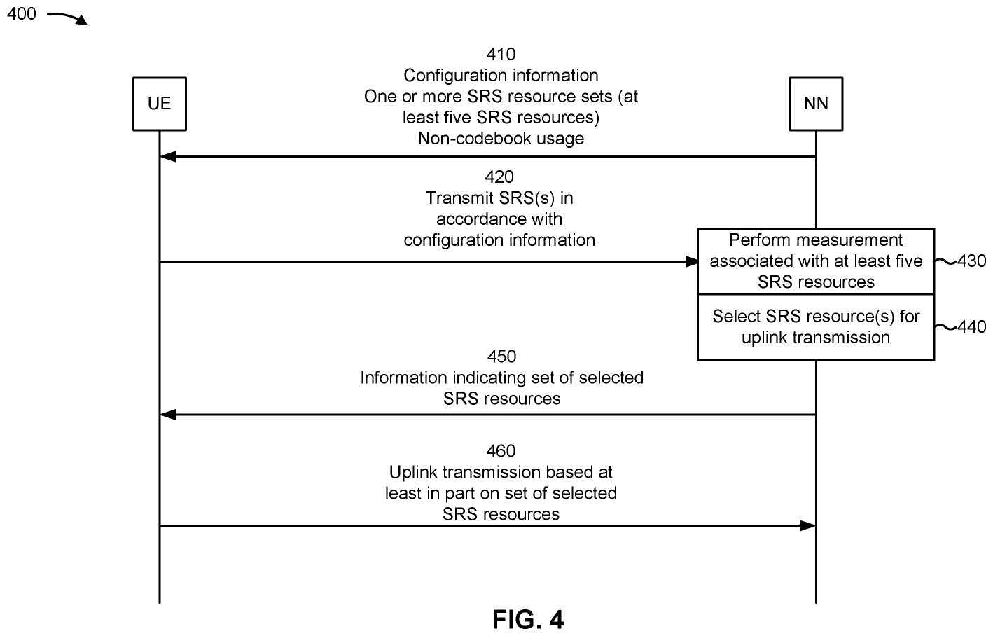

FIG. 4 is a diagram illustrating an example 400 of signaling associated with SRS resource configuration to support non-codebook uplink transmission, in accordance with the present disclosure. As shown, example 400 includes a UE (e.g., UE 120) and a network node (e.g., one or more network nodes 110).

As shown in FIG. 4, and by reference number 410, the network node may transmit configuration information to the UE. For example, the network node may transmit the configuration information, or the network node may cause another network node to transmit the configuration information. In some aspects, the network node may receive the configuration information. For example, a CU may provide the configuration information (or information indicating the configuration information) to the network node such that the network node can trigger SRS transmission or schedule uplink transmissions accordingly.

As shown, the configuration information may include a configuration of at least one SRS resource set. In some aspects, the configuration may configure at least one SRS resource set with at least five SRS resources. For example, the configuration may configure a single SRS resource set with more than four SRS resources. Additionally, or alternatively, the configuration may configure at least two SRS resource sets that collectively include at least five SRS resources. For example, the configuration may configure a first SRS resource set with a first number of SRS resources and a second SRS resource set with a second number of SRS resources. The at least one SRS resource set (e.g., the single SRS resource set or the at least two SRS resource sets) may be configured with a non-codebook usage. Thus, the network node may facilitate sounding of at least five SRS ports using respective precoders for precoder selection. Each SRS resource, of the at least five SRS resources, may correspond to (e.g., be configured with) an SRS port (e.g., one SRS port per SRS resource and one SRS resource per SRS port), and each SRS resource may be associated with a different SRS port, in some examples.

As shown by reference number 420, the UE may transmit one or more SRSs in accordance with the configuration information. For example, the UE may transmit the one or more SRSs in accordance with the at least five SRS resources. In such examples, the UE may perform precoding of the one or more SRSs using a set of precoders associated with the at least five SRS resources, and the UE may transmit the one or more SRSs on antennas (e.g., antenna ports) of the UE as configured by the at least five SRS resources. In some aspects, the UE may transmit the one or more SRSs in accordance with a triggering indication (e.g., a downlink control information (DCI) message, or the like), such as for aperiodic SRS transmission. For example, the node may transmit (or cause transmission of) the triggering indication. In some aspects, the UE may transmit the one or more SRSs in accordance with a configuration, such as a semi-persistent configuration or a periodic configuration. In such examples, the transmission of the one or more SRSs may be activated, such as by configuration of the periodic configuration or a MAC-CE or DCI message activating the semi-persistent configuration. For example, the network node may transmit (or may cause transmission of) the configuration, the MAC control element, or the DCI message.

As shown by reference number 430, the network node may perform a measurement associated with the at least five SRS resources (e.g., on time/frequency resources associated with the at least five SRS resources). For example, the network node may estimate the uplink channel based at least in part on the at least five SRS resources. In some aspects, the network node may receive information based at least in part on a measurement associated with the at least five SRS resources. For example, the network node may receive such information from an RU.

As shown by reference number 440, the network node may select SRS resources for an uplink transmission. For example, the network node may select a set of SRS resources. In some examples, the set of selected SRS resources may include the at least five SRS resources. For example, the network node may select the set of SRS resources for indication of a set of precoders for a non-codebook uplink transmission of the UE, and the non-codebook uplink transmission may include at least five layers. In some examples, the network node may select the set of SRS resources based at least in part on performing the measurement. For example, the network node may select a set of SRS resources associated with best measurements, of all SRS resources sounded by the UE.

As shown by reference number 450, the network node may transmit, and the UE may receive, information indicating the set of selected SRS resources. For example, the information indicating the set of selected SRS resources may indicate a set of SRS ports corresponding to the set of selected SRS resources. In some aspects, the set of selected SRS resources may include the at least five SRS resources. In some aspects, the information indicating the set of selected SRS resources may be for an uplink transmission. For example, the information indicating the set of selected SRS resources may include scheduling information for a non-codebook PUSCH transmission. If the non-codebook PUSCH transmission is to include X layers (where X is an integer), the set of selected SRS resources may include X SRS resources (e.g., one SRS resource, and thus one precoder, per layer).

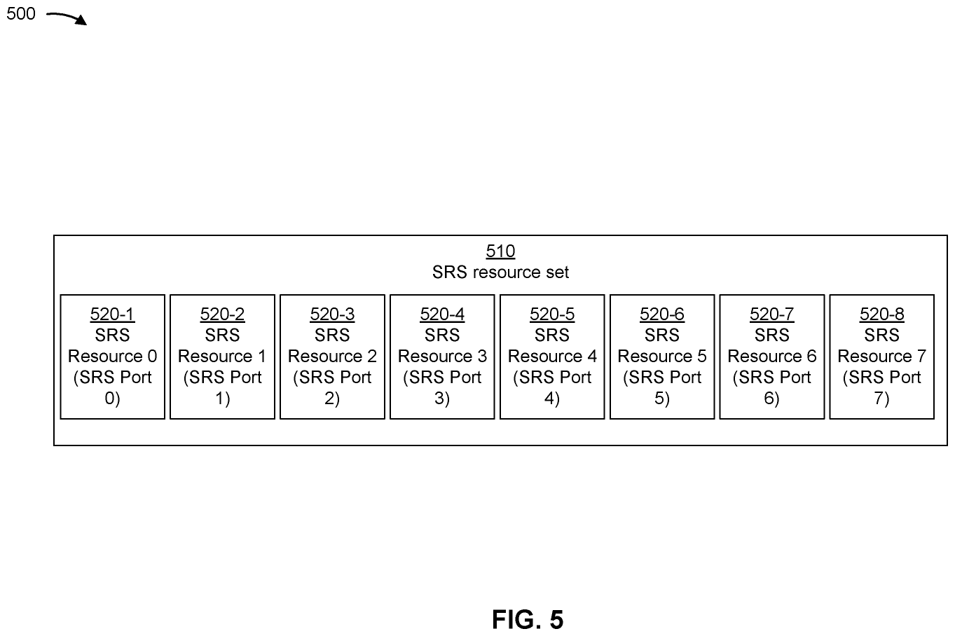

In some aspects, the information indicating the set of selected SRS resources may include an SRS resource indicator (SRI) field. For example, the information indicating the set of selected SRS resources may be a DCI message transmitted on a PDCCH and comprising an SRI field. For example, if the UE is configured with a single SRS resource set that includes more than five SRS resources (as shown in FIG. 5), the information indicating the set of selected SRS resources may include a single SRI field indicating selected SRS resources of the SRS resource set. In some aspects, the SRS resource set may include 8 SRS resources. If the SRS resource set includes 8 SRS resources, then the total number of combinations of X SRS ports (corresponding to X SRS resources, as described above) is:

$${\sum }_{X = 1}^{8} ( \begin{matrix}X \\ 8\end{matrix} ) = 255 ,$$

where (X₈)
denotes the number of combinations of X SRS ports that can be selected from 8 SRS ports. Thus, the total number of bits for the SRI field in this example is equal to

$$⌈ log 2 ( {\sum }_{X = 1}^{8} ( \begin{matrix}X \\ 8\end{matrix} ) ) ⌉ = 8 bits .$$

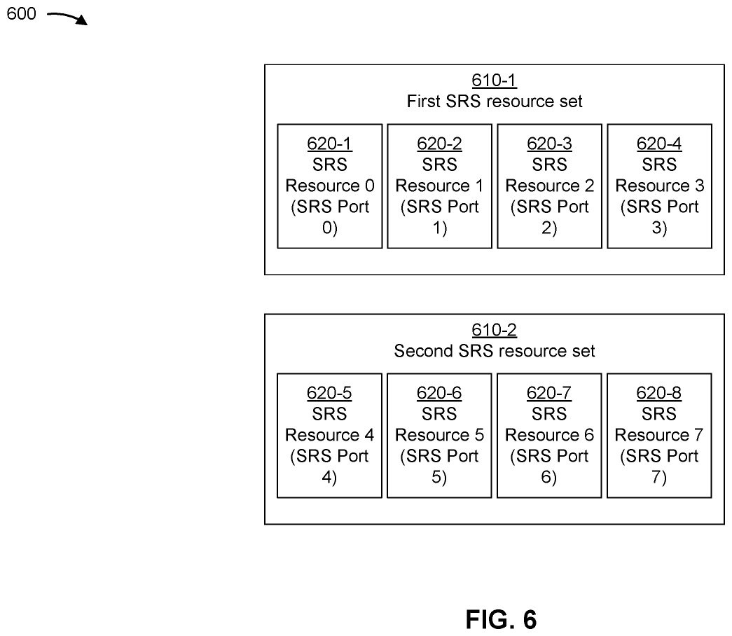

In some aspects, the UE is configured with multiple SRS resource sets (e.g., at least two SRS resource sets), as illustrated in FIG. 6. In some examples, the UE may be configured with a first SRS resource set and a second SRS resource set (e.g., with both SRS resource sets configured for non-codebook usage). The first SRS resource set may include up to four SRS resources, and the second SRS resource set may include up to four SRS resources. If the UE is configured with multiple SRS resource sets for non-codebook usage, the information indicating the set of selected SRS resources may indicate selected SRS resources from at least one of the first SRS resource set or the second SRS resource set. For example, the information indicating the set of selected SRS resources may be a DCI message transmitted on a PDCCH and comprising a first SRI field and a second SRI field. The first SRI field may indicate one or more selected SRS resources (e.g., one or more selected SRS ports) of the first SRS resource set, and the second SRI field may indicate one or more selected SRS resources (e.g., one or more selected SRS ports) of the second SRS resource set. In some aspects, the first SRI field may indicate no selected SRS resource of the first SRS resource set. In some aspects, the second SRI field may indicate no selected SRS resource of the second SRS resource set.

In some aspects, if there are X SRS resources in the set of selected SRS resources (collectively, across the first SRS resource set and the second SRS resource set) the first SRI field may indicate Y SRS resources out of four SRS resources of the first SRS resource set, and the second SRI field may indicate X-Y out of four SRS resources of the first SRS resource set. Thus, the first SRI field may indicate a proper subset of the set of selected SRS resources (e.g., less than all of the set of selected SRS resources). The second SRI field may indicate a remainder of the set of selected SRS resources (other than the proper subset indicated by the first SRI field). In such examples, the total number of combinations of the X SRS resources (and thus SRS ports) is

$${\sum }_{X = 1}^{8} {\sum }_{Y = max \{ 0 , X - 4 \}}^{min \{ 4 , X \}} ( \begin{matrix}Y \\ 4\end{matrix} ) ( \begin{matrix}X - Y \\ 4\end{matrix} ) = 255 ,$$

which may use 8 bits (4 bits for the first SRI field and 4 bits for the second SRI field). Thus, flexibility of selection of SRS resources is improved relative to SRI fields having a smaller bitwidth.

In some aspects, the network node may select the set of selected SRS ports so as to minimize a difference between a first number of selected SRS ports of a first SRS resource set (indicated above by Y), and a second number of selected SRS ports of a second SRS resource set (indicated above by X−Y). For example, the network node may select the set of selected SRS ports such that the first number is equal to the second number or differs from the second number by one. In other words, the network node may select the set of selected SRS ports such that Y and X−Y are equal or differ from one another by at most one. Below, examples of SRS resource selections for a first SRS resource set and a second SRS resource set so as to minimize a difference between the first number of selected SRS ports Y and the second number of selected SRS ports X−Y are represented, for different ranks of uplink transmission, as {Y, X−Y}:
Rank 1: {1, 0} or {0, 1}
Rank 2: {1, 1}
Rank 3: {1, 2} or {2, 1}
Rank 4: {2, 2}
Rank 5: {2, 3} or {3, 2}
Rank 6: {3, 3}
Rank 7: {4, 3} or {3, 4}
Rank 8: {4, 4}

In this example, the total number of combinations of X SRS resources is

$${\sum }_{X = 1}^{8} {\sum }_{Y = max \{ floor ( X / 2 ) , X - 4 \}}^{min \{ 4 , ceil ( X / 2 ) \}} ( \begin{matrix}Y \\ 4\end{matrix} ) ( \begin{matrix}X - Y \\ 4\end{matrix} ) = 181 ,$$

which uses 8 bits with a joint SRI (e.g., a first SRI and a second SRI) to indicate one out of the 181 potential combinations of X ports across the two SRS resource sets. Thus, the number of potential combinations of ports is reduced, which reduces processing complexity.

In some aspects, the network node may select the set of selected SRS ports so that, if the first number of selected SRS ports of the first SRS resource set differs from the second number of selected SRS ports of the second SRS resource set by one, the smaller number (of the first number and the second number) is predefined to be associated with a specific one of the first SRS resource set or the second SRS resource set. In some aspects, the network node may select the set of selected SRS ports such that an SRS resource set with a smaller set index is always associated with a smaller number, of the first number and the second number (assuming that the first number and the second number differ from one another). In some aspects, the network node may select the set of selected SRS ports such that an SRS resource set with a smaller set index is always associated with a larger number, of the first number and the second number (assuming that the first number and the second number differ from one another). Below, examples of SRS resource selections for a first SRS resource set and a second SRS resource set so that the SRS resource set with the smaller set index (that is, the first SRS resource set) is always associated with an equal or larger number of selected SRS resources than the SRS resource with the smaller set index (that is, the second SRS resource set) are represented, for different ranks of uplink transmission, as
{Y, X−Y}:
Rank 1: {1, 0}
Rank 2: {1, 1}
Rank 3: {2, 1}
Rank 4: {2, 2}
Rank 5: {3, 2}
Rank 6: {3, 3}
Rank 7: {4, 3}
Rank 8: {4, 4}

In this example, the total number of combinations of X SRS resources is

$${\sum }_{X = 1}^{8} {\sum }_{Y = max \{ floor ( X / 2 ) , X - 4 \}}^{min \{ 4 , ceil ( X / 2 ) \}} ( \begin{matrix}Y \\ 4\end{matrix} ) ( \begin{matrix}X - Y \\ 4\end{matrix} ) = 125 ,$$

which uses 7 bits with a joint SRI (e.g., a first SRI and a second SRI) to indicate one out of the 125 potential combinations of X ports across the two SRS resource sets. Thus, overhead associated with SRI indication can be reduced from 8 bits to 7 bits.

As shown by reference number 460, the UE may transmit an uplink transmission based at least in part on the set of selected SRS resources. For example, the UE may transmit a non-codebook PUSCH communication based at least in part on the set of selected SRS resources. The non-codebook PUSCH communication may have a number of layers equal to a number of SRS resources belonging to the set of selected SRS resources. The UE may precode the uplink transmission according to a set of precoders associated with the set of selected SRS resources. In this way, the network node can configure one or more SRS resource sets collectively including more than 4 SRS resources associated with non-codebook transmission by the UE, which facilitates non-codebook transmission using more than 4 layers.

As indicated above, FIG. 4 is provided as an example. Other examples may differ from what is described with regard to FIG. 4.

FIGS. 5 and 6 are diagrams illustrating examples 500 and 600 of at least one SRS resource set, in accordance with the present disclosure. Example 500 of FIG. 5 shows a single SRS resource set 510 configured with at least five SRS resources 520. Each SRS resource 520 is associated with a corresponding SRS port. As shown, each SRS resource 520 is associated with a different SRS port. The single SRS resource set 510 may be configured using RRC signaling. In some aspects, the single SRS resource set 510 may be configured using an SRS-ResourceSet RRC configuration and may be associated with a set index. A set index is a numerical identifier of an SRS resource set. The SRS resource set 510 may indicate the at least five SRS resources 520 based at least in part on SRS resource identifiers (e.g., an srs-ResourceId parameter) of the at least five SRS resources 520. The single SRS resource set 510 may be associated with a non-codebook usage.

Example 600 of FIG. 6 shows a first SRS resource set 610-1 and a second SRS resource set 610-2. Each SRS resource set 610 of FIG. 6 includes four SRS resources 620. For example, each SRS resource set 610 of FIG. 6 can be configured with up to four SRS resources 620, such that the SRS resource sets 610 of FIG. 6 collectively include configured with at least five SRS resources 620. Each SRS resource 620 is associated with a corresponding SRS port. As shown, each SRS resource 620 is associated with a different SRS port. Each SRS resource set 610 may be configured using RRC signaling. In some aspects, the first SRS resource set 610-1 may be configured using an SRS-ResourceSet RRC configuration and may be associated with a first set index. The second SRS resource set 610-2 may be configured using another SRS-ResourceSet RRC configuration (separate from the SRS-ResourceSet RRC configuration used for the first SRS resource set 610-1) and may be associated with a second set index. The SRS resource sets 610 may collectively indicate the at least five SRS resources 620 based at least in part on SRS resource identifiers (e.g., an srs-ResourceId parameter) of the at least five SRS resources 620. The SRS resource sets 610 may be associated with a non-codebook usage.

In some aspects, an SRS resource set 610 may be configurable with more than four SRS resources for non-codebook usage. For example, a network node may configure multiple SRS resource sets 610, and one or more of these SRS resource sets 610 may include more than four SRS resources 620.

As used herein, an SRS resource set includes an SRS resource if the SRS resource set is configured with an identifier of the SRS resource.

As indicated above, FIGS. 5 and 6 are provided as examples. Other examples may differ from what is described with regard to FIGS. 5 and 6.

FIG. 7 is a diagram illustrating an example process 700 performed, for example, by a UE, in accordance with the present disclosure. Example process 700 is an example where the UE (e.g., UE 120, the UE of FIGS. 4-6) performs operations associated with SRS resource configuration.

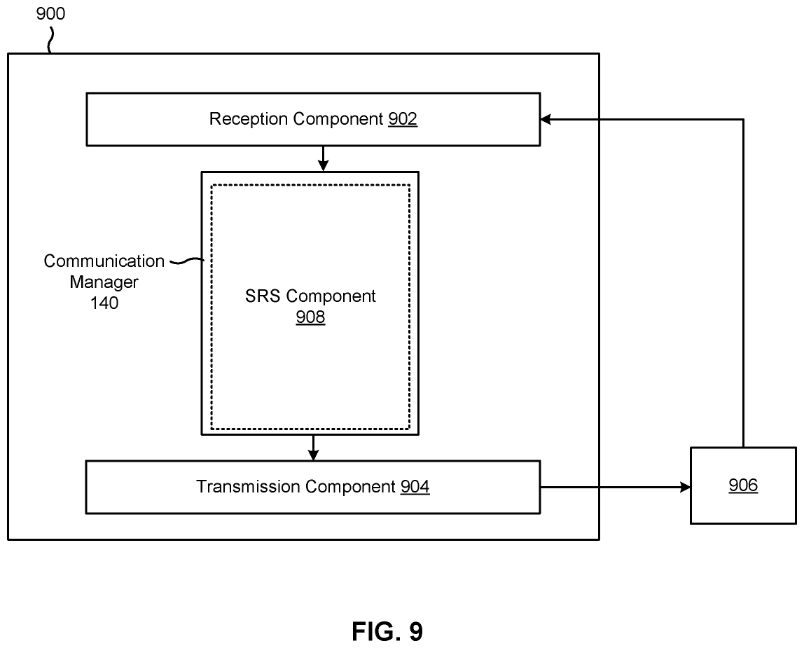

As shown in FIG. 7, in some aspects, process 700 may include receiving a configuration of at least one SRS resource set including at least five SRS resources or at least two SRS resource sets collectively including the at least five SRS resources, each SRS resource, of the at least five SRS resources, corresponding to an SRS port of at least five SRS ports (block 710). For example, the UE (e.g., using communication manager 140 and/or reception component 902, depicted in FIG. 9) may receive a configuration of at least one SRS resource set including at least five SRS resources or at least two SRS resource sets collectively including the at least five SRS resources, each SRS resource, of the at least five SRS resources, corresponding to an SRS port of at least five SRS ports, as described above.

As further shown in FIG. 7, in some aspects, process 700 may include receiving information indicating a set of selected SRS resources, including the at least five SRS resources, for an uplink transmission (block 720). For example, the UE (e.g., using communication manager 140 and/or reception component 902, depicted in FIG. 9) may receive information indicating a set of selected SRS resources, including the at least five SRS resources, for an uplink transmission, as described above.

As further shown in FIG. 7, in some aspects, process 700 may include transmitting the uplink transmission based at least in part on the set of selected SRS resources (block 730). For example, the UE (e.g., using communication manager 140 and/or transmission component 904, depicted in FIG. 9) may transmit the uplink transmission based at least in part on the set of selected SRS resources, as described above.

Process 700 may include additional aspects, such as any single aspect or any combination of aspects described below and/or in connection with one or more other processes described elsewhere herein.

In a first aspect, the at least one SRS resource set comprises a single SRS resource set including the at least five SRS resources.

In a second aspect, alone or in combination with the first aspect, an SRS resource indicator field of the information indicates a set of SRS ports corresponding to the set of selected SRS resources.

In a third aspect, alone or in combination with one or more of the first and second aspects, the at least two SRS resource sets include a first SRS resource set and a second SRS resource set.

In a fourth aspect, alone or in combination with one or more of the first through third aspects, a first SRI field of the information indicates a proper subset of the set of selected SRS resources, and wherein a second SRI field of the information indicates a remainder of the set of selected SRS resources, other than the proper subset of the set of selected SRS resources.

In a fifth aspect, alone or in combination with one or more of the first through fourth aspects, the proper subset includes a first number of SRS resources and the remainder includes a second number of SRS resources, wherein the first number is equal to the second number or differs from the second number by one.

In a sixth aspect, alone or in combination with one or more of the first through fifth aspects, the first number is greater than or equal to the second number.

In a seventh aspect, alone or in combination with one or more of the first through sixth aspects, the first number is lesser than or equal to the second number.

In an eighth aspect, alone or in combination with one or more of the first through seventh aspects, the first SRS resource set includes up to four SRS resources and the second SRS resource set includes up to four SRS resources.

In a ninth aspect, alone or in combination with one or more of the first through eighth aspects, the uplink transmission is a non-codebook PUSCH transmission.

In a tenth aspect, alone or in combination with one or more of the first through ninth aspects, the at least one SRS resource set or the at least two SRS resource sets are associated with a non-codebook usage.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110, the network node of FIGS. 4-6) performs operations associated with sounding reference signal resource configuration.

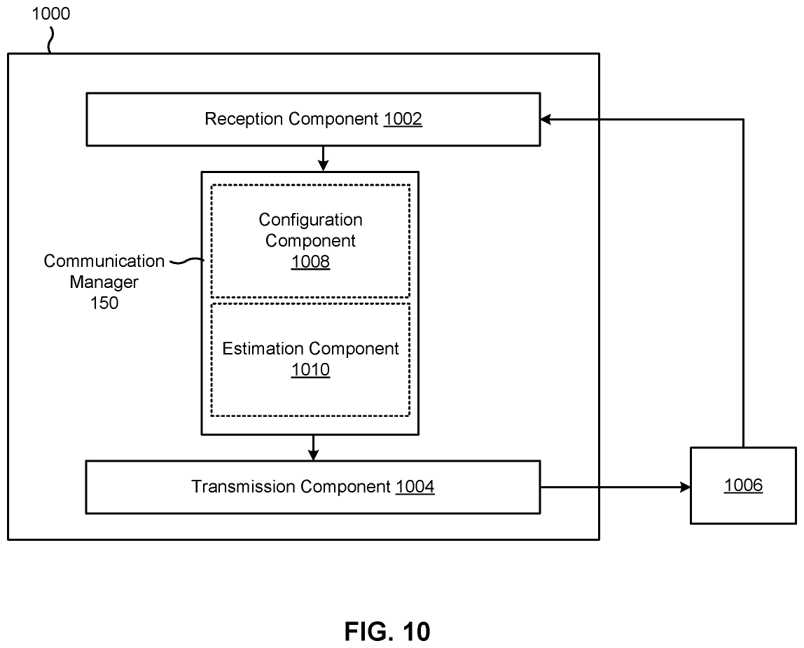

As shown in FIG. 8, in some aspects, process 800 may include receiving or transmitting a configuration of at least one SRS resource set including at least five SRS resources or at least two SRS resource sets collectively including the at least five SRS resources, each SRS resource, of the at least five SRS resources, corresponding to an SRS port of at least five SRS ports (block 810). For example, the network node (e.g., using communication manager 150 and/or reception component 1002, depicted in FIG. 10) may receive or transmitting a configuration of at least one SRS resource set including at least five SRS resources or at least two SRS resource sets collectively including the at least five SRS resources, each SRS resource, of the at least five SRS resources, corresponding to an SRS port of at least five SRS ports, as described above.

As further shown in FIG. 8, in some aspects, process 800 may include transmitting information indicating a set of selected SRS resources, including the at least five SRS resources, for an uplink transmission (block 820). For example, the network node (e.g., using communication manager 150 and/or transmission component 904, depicted in FIG. 9) may transmit information indicating a set of selected SRS resources, including the at least five SRS resources, for an uplink transmission, as described above.

Process 800 may include additional aspects, such as any single aspect or any combination of aspects described below and/or in connection with one or more other processes described elsewhere herein.

In a first aspect, the at least one SRS resource set comprises a single resource set including the at least five SRS resources.

In a second aspect, alone or in combination with the first aspect, an SRS resource indicator field of the information indicates a set of SRS ports corresponding to the set of selected SRS resources.

In a third aspect, alone or in combination with one or more of the first and second aspects, the at least two SRS resource sets include a first SRS resource set and a second SRS resource set.

In a fourth aspect, alone or in combination with one or more of the first through third aspects, a first SRI field of the information indicates a proper subset of the set of selected SRS resources, and wherein a second SRI field of the information indicates a remainder of the set of selected SRS resources, other than the proper subset of the set of selected SRS resources.

In a fifth aspect, alone or in combination with one or more of the first through fourth aspects, the proper subset includes a first number of SRS resources and the remainder includes a second number of SRS resources, wherein the first number is equal to the second number or differs from the second number by one.

In a sixth aspect, alone or in combination with one or more of the first through fifth aspects, the first number is greater than or equal to the second number.

In a seventh aspect, alone or in combination with one or more of the first through sixth aspects, the first number is lesser than or equal to the second number.

In an eighth aspect, alone or in combination with one or more of the first through seventh aspects, the first SRS resource set includes up to four SRS resources and the second SRS resource set includes up to four SRS resources.

In a ninth aspect, alone or in combination with one or more of the first through eighth aspects, the uplink transmission is a non-codebook PUSCH transmission.

In a tenth aspect, alone or in combination with one or more of the first through ninth aspects, the at least one SRS resource set or the at least two SRS resource sets are associated with a non-codebook usage.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include an SRS component 908, among other examples.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive a configuration of at least one SRS resource set including at least five SRS resources or at least two SRS resource sets collectively including the at least five SRS resources, each SRS resource, of the at least five SRS resources, corresponding to an SRS port of at least five SRS ports. The reception component 902 may receive information indicating a set of selected SRS resources, including the at least five SRS resources, for an uplink transmission. The transmission component 904 may transmit the uplink transmission based at least in part on the set of selected SRS resources. The SRS component 908 may transmit one or more SRSs based at least in part on the at least five SRS resources.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include one or more of a configuration component 1008 or an estimation component 1010, among other examples.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 may include an interface with another network node, such as a radio unit.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver. In some aspects, the transmission component 1004 may include an interface with another network node, such as a radio unit.

The reception component 1002 or the configuration component 1008 may receive or transmit a configuration of at least one SRS resource set including at least five SRS resources or at least two SRS resource sets collectively including the at least five SRS resources, each SRS resource, of the at least five SRS resources, corresponding to an SRS port of at least five SRS ports. The transmission component 1004 may transmit information indicating a set of selected SRS resources, including the at least five SRS resources, for an uplink transmission. The estimation component 1010 may perform a measurement associated with selecting the set of selected SRS resources.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports; receiving downlink control information indicating a set of selected SRS resources, including the at least five SRS resources, for an uplink transmission; and transmitting the uplink transmission based at least in part on the set of selected SRS resources.

Aspect 2: The method of Aspect 1, wherein the at least one SRS resource set comprises a single SRS resource set including the at least five SRS resources.

Aspect 3: The method of Aspect 2, wherein an SRS resource indicator field of the downlink control information indicates a set of SRS ports corresponding to the set of selected SRS resources.

Aspect 4: The method of Aspect 1, wherein the at least two SRS resource sets include a first SRS resource set and a second SRS resource set.

Aspect 5: The method of Aspect 4, wherein a first SRS resource indicator (SRI) field of the downlink control information indicates a proper subset of the set of selected SRS resources, and wherein a second SRI field of the downlink control information indicates a remainder of the set of selected SRS resources, other than the proper subset of the set of selected SRS resources.

Aspect 6: The method of Aspect 5, wherein the proper subset includes a first number of SRS resources and the remainder includes a second number of SRS resources, wherein the first number is equal to the second number or differs from the second number by one.

Aspect 7: The method of Aspect 6, wherein the first number is greater than or equal to the second number.

Aspect 8: The method of Aspect 6, wherein the first number is lesser than or equal to the second number.

Aspect 9: The method of Aspect 4, wherein the first SRS resource set includes up to four SRS resources and the second SRS resource set includes up to four SRS resources.

Aspect 10: The method of any of Aspects 1-9, wherein the uplink transmission is a non-codebook physical uplink shared channel (PUSCH) transmission.

Aspect 11: The method of any of Aspects 1-10, wherein the at least one SRS resource set or the at least two SRS resource sets are associated with a non-codebook usage.

Aspect 12: A method of wireless communication performed by a network node, comprising: receiving or transmitting a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports; and transmitting downlink control information indicating a set of selected SRS resources, including the at least five SRS resources, for an uplink transmission.

Aspect 13: The method of Aspect 12, wherein the at least one SRS resource set comprises a single resource set including the at least five SRS resources.

Aspect 14: The method of Aspect 13, wherein an SRS resource indicator field of the downlink control information indicates a set of SRS ports corresponding to the set of selected SRS resources.

Aspect 15: The method of Aspect 12, wherein the at least two SRS resource sets include a first SRS resource set and a second SRS resource set.

Aspect 16: The method of Aspect 15, wherein a first SRS resource indicator (SRI) field of the downlink control information indicates a proper subset of the set of selected SRS resources, and wherein a second SRI field of the downlink control information indicates a remainder of the set of selected SRS resources, other than the proper subset of the set of selected SRS resources.

Aspect 17: The method of Aspect 16, wherein the proper subset includes a first number of SRS resources and the remainder includes a second number of SRS resources, wherein the first number is equal to the second number or differs from the second number by one.

Aspect 18: The method of Aspect 17, wherein the first number is greater than or equal to the second number.

Aspect 19: The method of Aspect 17, wherein the first number is lesser than or equal to the second number.

Aspect 20: The method of Aspect 15, wherein the first SRS resource set includes up to four SRS resources and the second SRS resource set includes up to four SRS resources.

Aspect 21: The method of any of Aspects 12-20, wherein the uplink transmission is a non-codebook physical uplink shared channel (PUSCH) transmission.

Aspect 22: The method of any of Aspects 12-21, wherein the at least one SRS resource set or the at least two SRS resource sets are associated with a non-codebook usage.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports;
receive downlink control information indicating a set of selected SRS resources, including the at least five SRS resources, for an uplink transmission; and
transmit the uplink transmission based at least in part on the set of selected SRS resources.

2. The UE of claim 1, wherein the downlink control information indicating the set of selected SRS resources comprises one or more SRS resource indicator fields identifying the set of selected SRS resources.

3. The UE of claim 1, wherein the at least one SRS resource set comprises a single SRS resource set including the at least five SRS resources.

4. The UE of claim 3, wherein an SRS resource indicator field of the downlink control information indicates a set of SRS ports corresponding to the set of selected SRS resources.

5. The UE of claim 1, wherein the at least two SRS resource sets include a first SRS resource set and a second SRS resource set.

6. The UE of claim 5, wherein a first SRS resource indicator (SRI) field of the downlink control information indicates a proper subset of the set of selected SRS resources, and wherein a second SRI field of the downlink control information indicates a remainder of the set of selected SRS resources, other than the proper subset of the set of selected SRS resources.

7. The UE of claim 6, wherein the proper subset includes a first number of SRS resources and the remainder includes a second number of SRS resources, wherein the first number is equal to the second number or differs from the second number by one.

8. The UE of claim 7, wherein the first number is greater than or equal to the second number.

9. The UE of claim 7, wherein the first number is lesser than or equal to the second number.

10. The UE of claim 5, wherein the first SRS resource set includes up to four SRS resources and the second SRS resource set includes up to four SRS resources.

11. The UE of claim 1, wherein the uplink transmission is a non-codebook physical uplink shared channel (PUSCH) transmission.

12. The UE of claim 1, wherein the at least one SRS resource set or the at least two SRS resource sets are associated with a non-codebook usage.

13. A network node for wireless communication, comprising:
a memory; and
one or more processors, coupled to the memory, configured to:
receive or transmit a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports; and
transmit downlink control information indicating a set of selected SRS resources, including the at least five SRS resources, for an uplink transmission.

14. The network node of claim 13, wherein the downlink control information indicating the set of selected SRS resources comprises one or more SRS resource indicator fields identifying the set of selected SRS resources.

15. The network node of claim 13, wherein the at least one SRS resource set comprises a single resource set including the at least five SRS resources.

16. The network node of claim 14, wherein an SRS resource indicator field of the downlink control information indicates a set of SRS ports corresponding to the set of selected SRS resources.

17. The network node of claim 13, wherein the at least two SRS resource sets include a first SRS resource set and a second SRS resource set.

18. The network node of claim 17, wherein a first SRS resource indicator (SRI) field of the downlink control information indicates a proper subset of the set of selected SRS resources, and wherein a second SRI field of the downlink control information indicates a remainder of the set of selected SRS resources, other than the proper subset of the set of selected SRS resources.

19. The network node of claim 18, wherein the proper subset includes a first number of SRS resources and the remainder includes a second number of SRS resources, wherein the first number is equal to the second number or differs from the second number by one.

20. The network node of claim 19, wherein the first number is greater than or equal to the second number.

21. The network node of claim 19, wherein the first number is lesser than or equal to the second number.

22. The network node of claim 17, wherein the first SRS resource set includes up to four SRS resources and the second SRS resource set includes up to four SRS resources.

23. The network node of claim 13, wherein the uplink transmission is a non-codebook physical uplink shared channel (PUSCH) transmission.

24. The network node of claim 13, wherein the at least one SRS resource set or the at least two SRS resource sets are associated with a non-codebook usage.

25. A method of wireless communication performed by a user equipment (UE), comprising:
receiving a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports;
receiving downlink control information indicating a set of selected SRS resources, including the at least five SRS resources, for an uplink transmission; and
transmitting the uplink transmission based at least in part on the set of selected SRS resources.

26. The method of claim 25, wherein the downlink control information indicating the set of selected SRS resources comprises one or more SRS resource indicator fields identifying the set of selected SRS resources.

27. The method of claim 25, wherein a first SRS resource indicator (SRI) field of the downlink control information indicates a proper subset of the set of selected SRS resources, and wherein a second SRI field of the downlink control information indicates a remainder of the set of selected SRS resources, other than the proper subset of the set of selected SRS resources.

28. A method of wireless communication performed by a network node, comprising:
receiving or transmitting a configuration of at least one sounding reference signal (SRS) resource set including at least five SRS resources or at least two SRS resource sets collectively including the at least five SRS resources, each SRS resource, of the at least five SRS resources, corresponding to an SRS port of at least five SRS ports; and
transmitting downlink control information indicating a set of selected SRS resources, including the at least five SRS resources, for an uplink transmission.

29. The method of claim 28, wherein the downlink control information indicating the set of selected SRS resources comprises one or more SRS resource indicator fields identifying the set of selected SRS resources.

30. The method of claim 28, wherein a first SRS resource indicator (SRI) field of the downlink control information indicates a proper subset of the set of selected SRS resources, and wherein a second SRI field of the downlink control information indicates a remainder of the set of selected SRS resources, other than the proper subset of the set of selected SRS resources.
